(19) United States
(12) Patent Application Publication
(10) Pub. No.: US 2024/0278442 A1
(43) Pub. Date: Aug. 22, 2024

(54) MULTI-CUTTING ELEMENT SHAVING DEVICES

(71) Applicant: HYBRID RAZOR LTD., Haifa (IL)

(72) Inventors: Shai BRENNER, Haifa (IL); Shoam ZAK, Givat Ela (IL)

(21) Appl. No.: 18/569,025

(22) PCT Filed: Jun. 9, 2022
(86) PCT No.: PCT/IL2022/050616

§ 371 Date: Dec. 11, 2023

Related U.S. Application Data
(60) Provisional application No. 63/210,017, filed on Jun. 13, 2021.

(51) Int. Cl. B26B 19/16; B26B 19/38

(52) U.S. Cl. CPC B26B 19/16; B26B 19/386

(57) ABSTRACT

A multi-cutting element shaving device is disclosed. The device comprises a handle and a head portion comprising at least two cutting assemblies, which are mounted in parallel, to one another on a frame of the head portion. The cutting assemblies include each a cylindrical screen and a blade housed in the cylindrical screen. Each of said cylindrical screens is rotatable about a respective longitudinal symmetry axis thereof, and the rotation of each cylindrical screens is manually effected by translating the head portion along a surface with the cylindrical screen contacting the surface so that substantially no sliding, of the cylindrical screens occurs as the head portion is translated against the surface. The head portion mounting angle relative to the handle is changeable during use of the shaving device such that both cylindrical screens are simultaneously maintained in contact with the surface, which is being shaved.

### TECHNICAL FIELD

The present disclosure relates generally to shaving devices including a plurality of cutting elements.

### BACKGROUND

Methods for removing hair from skin surface, by shaving (i.e., cutting of the hair rather than pulling the hair (such as in epilation)), include the razor blade approach, where a very sharp blade is pushed against the skin at an angle, thereby cutting hair; and the screen approach, wherein a thin fenestrated metal screen is moved across the skin, exposing hair though the holes and cutting them by a mechanized, typically motorized, cutting element. There are several different types of devices used to shave body hair. These include disposable razors, electric razors, cartridge razors, safety razors, and straight razors. Electric razors also come in different types, including foil-style electric razors and rotary-style electric razors. In a foil-style electric razor, a thin, perforated, protective metal screen is provided, which covers the blades. The blades are sharp reciprocating or oscillating blades that move side-to-side at very high speed behind the protective metal screen. The user's hairs pass through openings in the protective metal screen (which is stationary) and are then cut as the blades oscillate back and forth. In a rotary-style electric razor, there are several circular screens that have an internally spinning cutter blade that cuts the hairs captured by the stationary circular screens.

However, in order to properly use the shaving device the user is required to properly maneuver the angle of the device and screen on the skin surface, which may be cumbersome and uncomfortable and in some cases may even cause cuts to the user.

In addition, in many cases the shaving device is configured to shave the hairs on the skin surface but comparatively longer hairs are missed out.

Thus, there is a need in the art for an improved shaving device that allows an efficient and safe shaving and removal of hair from a skin surface, in a comfortable manner. Moreover, there is a need in the art for an improved shaving device that allows shaving short hairs and comparatively long hairs in unison.

### SUMMARY

Aspects of the disclosure, according to some embodiments thereof, relate to shaving devices (e.g. electrical razors) including a plurality of cutting elements (e.g. a plurality of blades). More specifically, but not exclusively, aspects of the disclosure, according to some embodiments thereof, relate to electric shaving devices including a plurality of cutting elements, wherein each cutting element is housed within a rotatable foil head, and wherein, optionally, one of the cutting elements is a configured for trimming hairs.

According to some embodiments, a multi-cutting element shaving device s disclosed. The multi-cutting element shaving device comprises: a handle configured to be held by a user; and a head portion comprising at least two cutting assemblies, which are mounted in parallel, to one another on a frame of the head portion; a first cutting assembly includes a first cylindrical screen and a first blade housed in said first cylindrical screen and a second cutting assembly includes a second cylindrical screen and a second blade housed in said second cylindrical screen; wherein each of said first and second cylindrical screens is rotatable about a respective longitudinal symmetry axis thereof, and wherein the rotation of each of the first and second cylindrical screens is manually effected by translating the head portion along a surface which is being shaved with the cylindrical screen contacting said surface so that substantially no sliding, of the first and second cylindrical screens occurs as the head portion is translated against said surface, and wherein the head portion mounting angle at which the head portion is mounted relative to the handle is changeable during use of the shaving device such that both first cylindrical screen and second cylindrical screen are simultaneously maintained in contact with said surface. Advantageously, the fact that both screens are simultaneously maintained in contact with the surface, which is being shaved ease the use of the shaving device and enables to shave without needing to maneuvering and changing the angle of use when going over the surface being shaved.

According to some embodiments, the first and second cylindrical screens constitute a perforated cylindrical shell defining an inner volume wherein the first and second blades are accommodated respectively.

According to some embodiments, each of the first and second blades is configured for oscillating motion along, or in parallel to, the longitudinal symmetry axis of the respective cylindrical screen.

According to some embodiments, the handle and the head portion are mechanically associated via a pivoting mechanism wherein a pivoting extends transversely from a first sidewall of the frame to a second sidewall of the frame and in parallel to the surface which is being shaved and the head portion is configured to allow turning thereof about the pivoting axis, thereby changing the mounting angle.

According to some embodiments, the first cutting assembly is essentially identical to the second cutting assembly.

According to some embodiments, the first and second blades include curved, sharp crests which extends along a top section of the first and second blades such that the top section is shaped as a half-cylinder with crests extending circumferentially thereon in parallel to one another.

According to some embodiments, the first and second cylindrical screens include holes, wherein when the first and second cylindrical screens are rolled along a skin surface, hairs on the skin surface penetrate into a cavity via the holes and are cut by the first and second blades.

According to some embodiments, the surface is a skin surface.

According to some embodiments, said shaving device is powered by a battery or via a power cord.

According to some embodiments, in said first and second cutting assemblies, rows of holes on the first and second screens are arranged such as to define a helix about a longitudinal symmetry axis of the first and second cylindrical screens respectively.

According to some embodiments, holes on the first and second screens are elongated along a length of a loop on which the holes are disposed.

According to some embodiments, the first and second blades are mounted on a shaft via an elongate hole, which extends therethrough along a length thereof, such as to allow for reciprocating motion of the first blade along the shaft back and forth towards and away from a first sidewall of the frame, and the second blade along the shaft back and forth away from and towards a second sidewall of the frame.

According to some embodiments, the multi-cutting element shaving device further comprises a third cutting assembly configured for trimming comparatively longer hairs, which includes a third cylindrical screen and a third blade, which includes curved, sharp crests which extends along a top section of the third blade such that the top section is shaped as a half-cylinder with crests extending circumferentially thereon in parallel to one another.

According to some embodiments, the third cutting assembly is positioned between the first cutting assembly and the second cutting assembly.

According to some embodiments, the first cutting assembly is positioned between the third cutting assembly and the second cutting assembly.

According to some embodiments, the second cutting assembly is positioned between the third cutting assembly and the first cutting assembly.

According to some embodiments, one operation modes is selected between the following modes:
a shaving mode wherein only the first cutting assembly and the second cutting assembly are operating;
a trimming mode, wherein only the third cutting assembly is operating; and
a combined mode, wherein all of cutting assemblies are operating together.

According to some embodiments, rows of holes on the third cylindrical screen are arranged such as to define a helix about a longitudinal symmetry axis of the third cylindrical screen.

According to some embodiments, the holes are elongated along a length of a loop on which the holes are disposed.

According to some embodiments, the third cylindrical screen includes closed loops positioned adjacently to one another, such that each loop is offset in the sense of having a symmetry axis that is disposed at an angle relative to the longitudinal axis of the third cylindrical screen.

According to some embodiments, the third cylindrical screen is configured to be rotatable about a longitudinal axis thereof manually or by a motor, and wherein the third blade is stationary with the rotation of the third cylindrical screen resulting in what effectively amounts to an axial relative motion between the crests and the holes.

According to some embodiments, the third cutting assembly includes a pair of comb-like blades, such as blades of a hair clipper.

According to some embodiments, the shaving device includes only the first cutting assembly configured for shaving short hairs and the third cutting assembly configured for trimming comparatively longer hairs.

According to some embodiments, the first second and third cylindrical screens are rotatable by a motor and wherein rotation of said first second and third cylindrical screens obviates a need for reciprocating motion of the blades therein.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In the figures:

FIG. 1A presents a perspective view of a shaving device including a plurality of cutting elements, according to some embodiments;

FIG. 1B presents an exploded view of a cutting assembly of the shaving device of FIG. 1A, according to some embodiments;

FIG. 2A presents a perspective view of a shaving device including a plurality of cutting elements, wherein some of the cutting elements are configured for shaving hairs and one of the cutting elements is configured for trimming hairs, according to some embodiments;

FIG. 2B presents a front view of cylindrical screen of a trimmer assembly of the shaving device of FIG. 2A, the cylindrical screen being configured to accommodate a trimmer, according to some embodiments; and

FIG. 2C presents a front view of a blade of the trimmer assembly of the shaving device of FIG. 2A, according to some embodiments.

### DETAILED DESCRIPTION

The principles, uses, and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the description and claims of the application, the words “include” and “have”, and forms thereof, are not limited to members in a list with which the words may be associated.

As used herein, the term “about” may be used to specify a value of a quantity or parameter (e.g. the length of an element) to within a continuous range of values in the neighborhood of (and including) a given (stated) value. According to some embodiments, “about” may specify the value of a parameter to be between 80% and 120% of the given value. For example, the statement “the length of the element is equal to about 1 m” is equivalent to the statement “the length of the element is between 0.8 m and 1.2 m”. According to some embodiments, “about” may specify the value of a parameter to be between 90% and 110% of the given value. According to some embodiments, “about” may specify the value of a parameter to be between 95% and 105% of the given value.

As used herein, according to some embodiments, the terms “substantially” and “about” may be interchangeable.

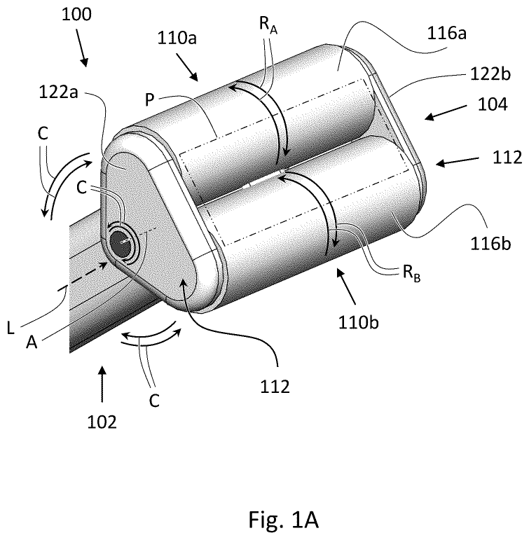

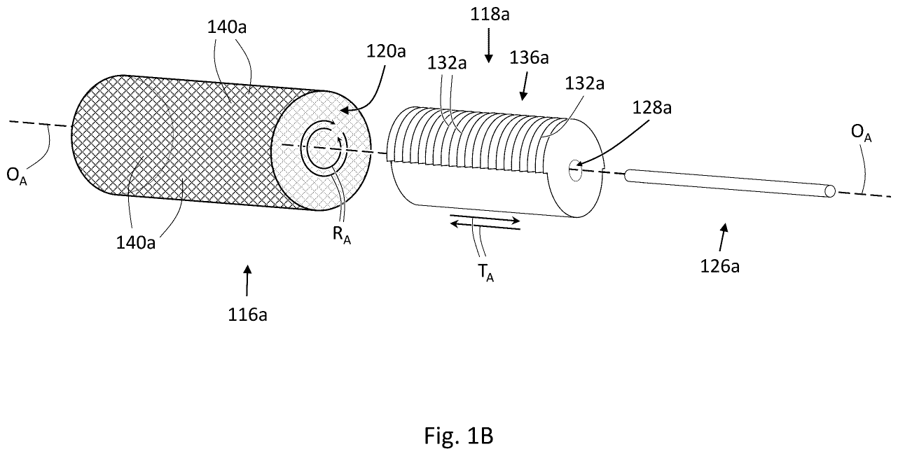

FIG. 1A schematically depicts a multi-cutting element shaving device 100 (i.e. a shaving device including a plurality of cutting elements), according to some embodiments. Shaving device 100 includes a handle 102 (partially shown), configured to be held by a user, and a head portion 104. Head portion 104 includes a plurality of cutting assemblies 110 (e.g. two in FIG. 1A): a first cutting assembly 110a and a second cutting assembly 110b. Cutting assemblies 110 may be mounted adjacently and in parallel, or substantially in parallel, to one another on a frame 112 of head portion 104.

Each cutting assembly includes a cylindrical screen and a blade: First cutting assembly 110a includes a cylindrical screen 116a and a blade 118a (shown in FIG. 1B) housed within screen 116a. More specifically, cylindrical screen 116a may constitute a perforated (cylindrical) shell defining an inner volume 120a (shown in FIG. 1B), wherein blade 118a is accommodated. Similarly, second cutting assembly 110b may include a (perforated) cylindrical screen 116b and a blade (not visible in FIG. 1A) housed within screen 116b. According to some embodiments, each of screens 116a and 116b may be rotatable about a respective longitudinal symmetry axis thereof, as indicated by curved arrows R_{A} and R_{B}, respectively. According to some embodiments, the rotation of each of screens 116 may be manually effected by translating head portion 104 along a (skin) surface with the screen contacting the surface. According to some such embodiments, no sliding, or substantially no sliding, of screens 116 occurs as head portion 104 is translated against the surface (so that screens 116 effect pure, or substantially pure, rolling motion on the skin surface). Each of the blades may be configured for oscillating (e.g. reciprocating) motion along, or in parallel to, the longitudinal symmetry axis of the respective screen, as further elaborated on below in the description of FIG. 1B, and as described in detail in PCT application no. PCT/IL2020/050079 to S. Brenner and Z. Shoam, which is incorporated herein by reference in its entirety.

Shaving device 100 may be configured to allow head portion 104 to change a (mounting) angle (not indicated) at which head portion 104 is mounted relative to handle 102. The mounting angle is defined as the angle between a longitudinal axis L of handle 102 and a (flat) plane P (indicated by a rectangle outlined by a dashed-double-dotted line), which is tangent to each of screens 116a and 116b. In particular, shaving device 100 is configured to allow head portion 104 to change the angle thereof relative to handle 102 during use of shaving device 100 (i.e. while shaving), such that both first screen 116a and second screen 116b are simultaneously maintained in contact with a skin surface, which is being shaved.

More specifically, handle 102 and head portion 104 may be mechanically associated via a pivoting mechanism. A pivoting axis A (partially shown) extends transversely from a first sidewall 122a of frame 112 to a second sidewall 122b of frame 112 and in parallel to the plane P. As indicated by curved arrows C, head portion 104 is configured to allow turning thereof about the pivoting axis A, thereby changing the mounting angle. In use, for example, when shaving a face, head portion 104 may first be brought into contact with a skin surface to be shaved (e.g. a cheek) at a bottom part of thereof (e.g. at the jawbone). Handle 102 is then maneuvered so as to move head portion 104 along the skin surface against the direction of the growth of hairs (e.g. from the bottom of the cheek to the top thereof). If head portion 104 is initially oriented with respect to handle 102, such that only second screen 116b contacts the skin surface, then the torque exerted on head portion 104 (as it is moved along the skin surface) by the skin surface, will turn head portion 104, so as to additionally bring first screen 116a into contact with the skin surface.

Referring to FIG. 1B, FIG. 1B presents a schematic exploded view of cutting assembly 110a, according to some embodiments. Shown are screen 116a, blade 118a, and a shaft 126a. Shaft 126a may extend from first sidewall 122a to second sidewall 122b. Also indicated is an axis OA, which extends along a length of shaft 126a, and which is parallel to, or coincides with, the longitudinal symmetry axis of screen 116a. Blade 118a may be mounted on shaft 126a via an elongate hole 128a, which extends therethrough along a length thereof, such as to allow for reciprocating motion of blade 118a along shaft 126a, i.e. back and forth towards (away from) and away from (towards) first sidewall 122a (second sidewall 122b), as indicated by arrows TA.

According to some embodiments, blade 118a includes curved, sharp crests 132a (i.e. sharp ridges; only some of which are numbered) extending along a top section 136a of blade 118a. More precisely, top section 136a may be shaped as a half-cylinder with crests 132a extending circumferentially thereon in parallel to one another. Screen 116a includes holes 140a (i.e. perforations; only some of which are numbered). When shaving device 100 is in use—i.e. when screen 116a is rolled along a skin surface, hairs on the skin surface penetrate into cavity 120a—via holes 140a—and are cut by blade 118a.

Cutting assembly 110b may be essentially identical to cutting assembly 110a.

The reciprocating motion of the blades of cutting assemblies 110 may be induced by an electrical motor (not shown) within head portion 104, in an essentially similar to a standard foil-type electrical razor. In such embodiments, shaving device 100 may be powered by a battery or via a power cord (connectable to an electrical wall socket). According to some embodiments, not depicted in the figures, shaving device 100 may include three or more cutting assemblies, which may be simultaneously brought into contact with a (skin) surface.

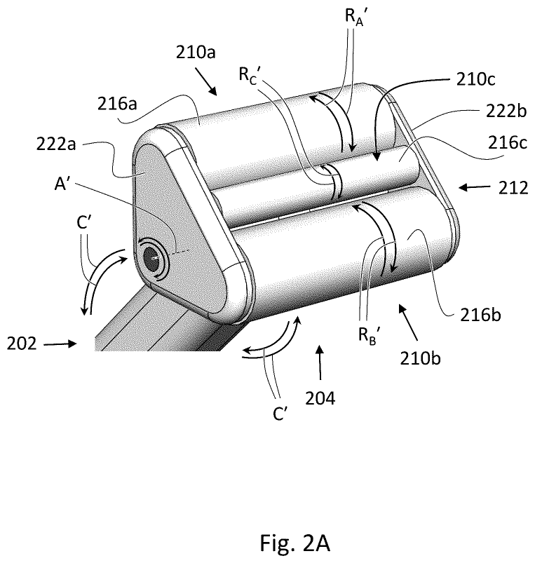

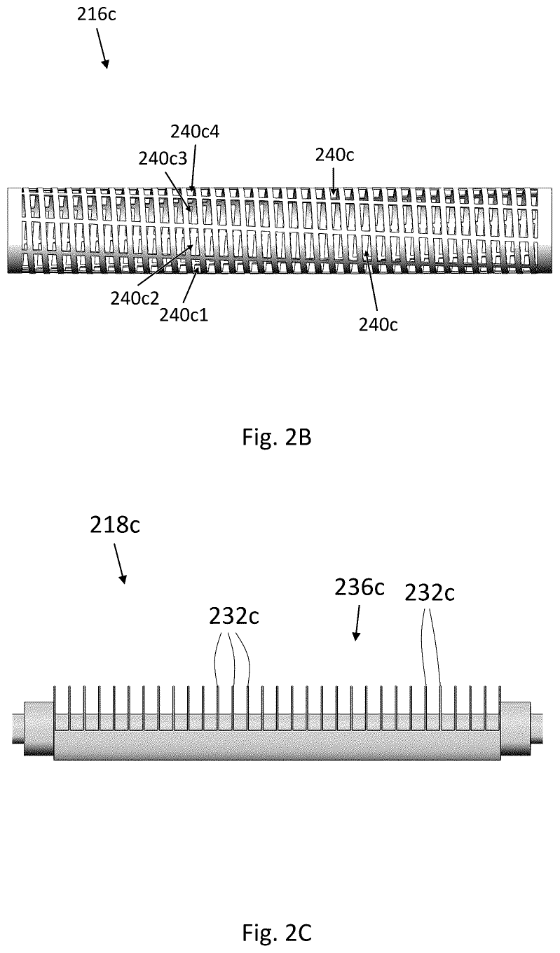

FIG. 2A schematically depicts a multi-cutting element shaving device 200, according to some embodiments. Shaving device 200 includes a handle 202 (partly shown), configured to be held by a user, and a head portion 204. Head portion 204 includes a plurality of cutting assemblies 210 (e.g. three in FIG. 2A): a first cutting assembly 210a, a second cutting assembly 210b, and a third cutting assembly 210c. Cutting assemblies 210 may be mounted adjacently and in parallel, or substantially in parallel, to one another on a frame 212 of head portion 204. Each of cutting assemblies 210a and 210b is essentially similar to cutting assemblies 110 of shaving device 100. That is, cutting assembly 210a includes a screen 216a, which may be similar to screen 116a, and a blade (not shown), which may be similar to blade 118a. Similarly, cutting assembly 210b includes a screen 216b, which may be similar to screen 116a, and a blade not shown, which may be similar to blade 118a.

Also indicated in FIG. 2A is a screen 216c of third cutting assembly 210c, a first sidewall 222a and a second sidewall 222b of frame 212. According to some embodiments, screen 216c may be rotatable, as indicated by arrow R_{C}′. According to some embodiments, the rotation of screen 216c may be manually effected by translating head portion 204 along a (skin) surface with the screen contacting the surface. According to some embodiments, each of screens 216a and 216b may also be rotatable (e.g. manually rotatable), as indicated by arrows R_{A}′ and R_{B}′, respectively. According to some such embodiments, no sliding, or substantially no sliding, of screens 216 occurs as head portion 204 is translated against the surface.

In contrast to cutting assemblies 210a and 210b, third cutting assembly 210c is configured for cutting comparatively longer hairs (i.e. trimming). According to some embodiments, and as depicted in FIG. 2A, third cutting assembly 210c may be positioned between first cutting assembly 210a and second cutting assembly. According to other embodiments, first cutting assembly 210a (second cutting assembly 210b) may be positioned between third cutting assembly 210c and second cutting assembly 210b (first cutting assembly 210a).

According to some embodiments, shaving device 200 may be configured such that, in use, all of cutting assemblies 210 operate in unison, thereby allowing to shave both short hairs and longer hairs. As head portion 204 is glided along a skin surface, longer hairs, which are “missed” by cutting assemblies 210a and 210b, may be cut (i.e. shortened) by third cutting assembly 210c and subsequently—as the skin surface is traversed again by head portion 204—shaved by cutting assemblies 210a and 210b.

According to some embodiments, shaving device 200 may allow a user to select between (i) a shaving mode, wherein only first cutting assembly 210a and second cutting assembly 210b are operating, a (ii) trimming mode, wherein only third cutting assembly 210c is operating, and (iii) a combined mode, wherein all of cutting assemblies 210 are operating together.

According to some embodiments, head portion 204 may be pivoted with respect to handle 204, as indicated by curved arrows C′. More specifically, handle 202 and head portion 204 may be mechanically associated via a pivoting mechanism essentially similar to the pivoting mechanism mechanically associating handle 102 and head portion 104 of shaving device 100. The pivoting mechanism allows for screens 216 to remain simultaneously in contact with a skin surface along which head portion 204 is being glided during use of the shaving device 200, essentially as described above with respect to shaving device 100.

Similarly to shaving device 100, shaving device 200 may include an electrical motor (not shown) for the powering thereof. In particular, the motor may be configured to induce reciprocating motion within screen 216c (along the length thereof) of the blade (shown in FIG. 2C) of third cutting assembly 210c.

Referring to FIGS. 2B and 2C, FIG. 2B presents a front view of screen 216c of third cutting assembly 210c (also referred to herein as “trimmer assembly”), according to some embodiments. FIG. 2C presents a front view of a blade 218c of third cutting assembly 210c, according to some embodiments. Blade 218c includes curved, sharp crests 232c extending along a top section 236c of blade 218c. According to some embodiments, a distance between crests 232c and screen 216c may be greater than a distance between crests 132a and screen 116a of first cutting assembly 110a—third cutting assembly 210c being thereby configured for trimming rather than (close) shaving.

According to some embodiments, and as depicted in FIG. 2B, rows of holes 240c on screen 216c may be arranged such as to define a helix about a longitudinal symmetry axis (not shown) of screen 216c. To graphically illustrate this point, four consecutive holes 240c1, 240c2, 240c3, and 240c4 along a same loop of the helix are indicated in FIG. 2B.

According to some embodiments, and as depicted in FIG. 2B, holes 240c may be elongated along a length of the loop on which the holes are disposed.

Alternatively, according to some embodiments, screen 216c may include closed (i.e. ring-shaped) loops positioned adjacently to one another. Each loop may be “offset” in the sense of having a symmetry axis that is disposed at an angle of e.g. about 20° relative to the longitudinal axis of the screen.

According to some embodiments, wherein the rows of holes on screen 216c define a helix or are arranged in offset (closed) loops, screen 216c may be configured to be rotatable about the longitudinal axis thereof (e.g. manually as described above and/or by the motor). According to some such embodiments, the blade 218c may be stationary, with the rotation of screen 216c resulting in what effectively amounts to an axial relative motion between crests 236c and holes 240c.

According to some embodiments, not depicted in FIG. 2C, third cutting assembly 210c may include a pair of comb-like blades, such as the blades of the hair clipper (instead of a single blade such as blade 218c).

According to some embodiments, not depicted in the figures, shaving device 200 may include only two cutting assemblies: a cutting assembly (such as first cutting assembly 210a), configured for shaving short hairs, and a cutting assembly (such as third cutting assembly 210c) configured for trimming comparatively longer hairs.

According to some embodiments, the screens of cutting assemblies 110 and/or cutting assemblies 210a and 210b may be helically-formed or formed of offset (closed) loops, essentially as described above in the description of third cutting assembly 210c. According to some such embodiments, the screens may be rotatable by the motor. In some such embodiments, the rotation of the screens may obviate the need for reciprocating motion of the blades therein.

While in FIGS. 1A and FIGS. 1B arrows R_{A} are shown as including two arrows indicating both clockwise and anti-clockwise rotation of screen 116a, respectively, and arrows R_{B} are shown in FIG. 1A as including two arrows indicating both clockwise and anti-clockwise rotation of screen 116b, respectively, according to some embodiments, not depicted in the figures, screens 116 may be rotatable only in one sense. According to some such embodiments, particularly embodiments wherein screens 116 are manually rotatable, when shaving device 100 is moved along a skin surface in one direction (e.g. pushed), screens 116 will rotate (e.g. purely, or substantially, purely rolling on the skin surface), and when shaving device 100 is moved along the skin surface in the opposite direction (e.g. pulled), head portion 104 will slide along the skin surface. Similarly, according to some embodiments, screens 216 may be rotatable only in one sense.

According to some embodiments, screens 116 may be locked so as to prevent rotation thereof. According to some embodiments, shaving device 100 may include a mode of operation wherein one of screens 116 is locked and the other is capable of rotating. Similarly, according to some embodiments, screens 216 may be locked, so as to prevent rotation thereof. According to some embodiments, shaving device 200 may include a mode of operation wherein some of screens 216 are locked and other of screens 216 are capable of rotating.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods according to some embodiments may be described in a specific sequence, methods of the disclosure may include some or all of the described stages carried out in a different order. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications, and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to ease understanding of the specification and should not be construed as necessarily limiting.

1. A multi-cutting element shaving device, comprising:
a handle configured to be held by a user; and
a head portion comprising at least two cutting assemblies, which are mounted in parallel, to one another on a frame of the head portion; a first cutting assembly includes a first cylindrical screen and a first blade housed in said first cylindrical screen and a second cutting assembly includes a second cylindrical screen and a second blade housed in said second cylindrical screen; wherein each of said first and second cylindrical screens is rotatable about a respective longitudinal symmetry axis thereof, and wherein the rotation of each of the first and second cylindrical screens is manually effected by translating the head portion along a skin surface which is being shaved with the cylindrical screen contacting said surface so that substantially no sliding, of the first and second cylindrical screens occurs as the head portion is translated against said surface, and wherein the head portion mounting angle at which the head portion is mounted relative to the handle is changeable during use of the shaving device such that both first cylindrical screen and second cylindrical screen are simultaneously maintained in contact with said surface.

2. The multi-cutting element shaving device of claim 1, wherein the first and second cylindrical screens constitute a perforated cylindrical shell defining an inner volume wherein the first and second blades are accommodated respectively.

3. The multi-cutting element shaving device of claim 1, wherein each of the first and second blades is configured for oscillating motion along, or in parallel to, the longitudinal symmetry axis of the respective cylindrical screen.

4. The multi-cutting element shaving device of claim 1, wherein the handle and the head portion are mechanically associated via a pivoting mechanism wherein a pivoting extends transversely from a first sidewall of the frame to a second sidewall of the frame and in parallel to the surface which is being shaved and the head portion is configured to allow turning thereof about the pivoting axis, thereby changing the mounting angle.

5. The multi-cutting element shaving device of claim 1, wherein the first cutting assembly is essentially identical to second cutting assembly.

6. The multi-cutting element shaving device of claim 1, wherein the first and second blades include curved, sharp crests which extends along a top section of the first and second blades such that the top section is shaped as a half-cylinder with crests extending circumferentially thereon in parallel to one another.

7. The multi-cutting element shaving device of claim 1, wherein the first and second cylindrical screens include holes, wherein when the first and second cylindrical screens are rolled along a skin surface, hairs on the skin surface penetrate into a cavity via the holes and are cut by the first and second blades.

8. (canceled)

9. The multi-cutting element shaving device of claim 1, wherein said shaving device is powered by a battery or via a power cord.

10. The multi-cutting element shaving device of claim 1, wherein in said first and second cutting assemblies, rows of holes on the first and second screens are arranged such as to define a helix about a longitudinal symmetry axis of the first and second cylindrical screens respectively.

11. The multi-cutting element shaving device of claim 1, wherein holes on the first and second screens are elongated along a length of a loop on which the holes are disposed.

12. The multi-cutting element shaving device of claim 1, wherein the first and second blades are mounted on a shaft via an elongate hole, which extends therethrough along a length thereof, such as to allow for reciprocating motion of the first blade along the shaft back and forth towards and away from a first sidewall of the frame, and the second blade along the shaft back and forth away from and towards a second sidewall of the frame.

13. The multi-cutting element shaving device of claim 1, further comprising a third cutting assembly configured for trimming comparatively longer hairs, which includes a third cylindrical screen and a third blade, which includes curved, sharp crests which extends along a top section of the third blade such that the top section is shaped as a half-cylinder with crests extending circumferentially thereon in parallel to one another.

14. The multi-cutting element shaving device of claim 13, wherein the third cutting assembly is positioned between the first cutting assembly and the second cutting assembly.

15. The multi-cutting element shaving device of claim 13, wherein the first cutting assembly is positioned between the third cutting assembly and the second cutting assembly.

16. The multi-cutting element shaving device of claim 13, wherein the second cutting assembly is positioned between the third cutting assembly and the first cutting assembly.

17. The multi-cutting element shaving device of claim 13, wherein one operation modes is selected between the following modes:
a shaving mode wherein only the first cutting assembly and the second cutting assembly are operating;
a trimming mode, wherein only the third cutting assembly is operating; and
a combined mode, wherein all of cutting assemblies are operating together.

18. The multi-cutting element shaving device of claim 13, wherein rows of holes on the third cylindrical screen are arranged such as to define a helix about a longitudinal symmetry axis of the third cylindrical screen.

19. The multi-cutting element shaving device of claim 18, wherein the holes are elongated along a length of a loop on which the holes are disposed.

20. The multi-cutting element shaving device of claim 13, wherein the third cylindrical screen includes closed loops positioned adjacently to one another, such that each loop is offset in the sense of having a symmetry axis that is disposed at an angle relative to the longitudinal axis of the third cylindrical screen.

21. The multi-cutting element shaving device of claim 18, wherein the third cylindrical screen is configured to be rotatable about a longitudinal axis thereof manually or by a motor, and wherein the third blade is stationary with the rotation of the third cylindrical screen resulting in what effectively amounts to an axial relative motion between the crests and the holes.

22. (canceled)

23. (canceled)

24. (canceled)
